(19) United States
(12) Patent Application Publication
(10) Pub. No.: US 2013/0236594 A1
(43) Pub. Date: Sep. 12, 2013

(54) PALATE CLEANER WINE COOKIE

(71) Applicant: Hazel B. Juliani, Wellesley, MA (US)

(72) Inventor: Hazel B. Juliani, Wellesley, MA (US)

(21) Appl. No.: 13/816,920

(22) PCT Filed: Aug. 15, 2011
(86) PCT No.: PCT/US11/47754

§ 371 Date: May 28, 2013

Related U.S. Application Data
(60) Provisional application No. 61/373,486, filed on Aug. 13, 2010.

(51) Int. Cl. A21D 2/36; A21D 13/08

(52) U.S. Cl. CPC A21D 2/368; A21D 13/08
USPC 426/2; 426/549; 426/503; 426/548; 426/553

(57) ABSTRACT

The present invention relates to a palate cleanser wine cookie, a method of cleansing the palate of a person for wine tastings using the cookie, a process of cleansing the palate of a person for wine tastings using the cookie, and a process for preparing a palate cleanser wine cookie. The palate cleanser wine cookie is useful for palate cleansing and as a palate-cleansing tool for purposes of correctly tasting a wine.

### CROSS REFERENCE TO RELATED APPLICATIONS

This application claims the benefit of U.S. Provisional Application No. 61/373,486, filed Aug. 13, 2010, the entire contents of which are hereby incorporated by reference herein.

### BACKGROUND

While the Palate Cleanser Wine Cookie™ is, for lack of a better definition, a type of food and its closest competitors may be considered part of the snack food industry, its functionality as a tool to prepare the palate for tastings is so unique as to possibly classify the product as part of its own industry, the “Palate Cleansing Tools” Industry. Just as it would not be appropriate to classify the well-documented and growingly-popular “miracle fruit” as fresh produce, it would not be appropriate to consider the Palate Cleanser Wine Cookie™ a snack food. Although the products are called cookies, they do not necessarily fit into this segment of the market or fit into this categorization.

The Palate Cleanser Wine Cookie™ is a consistent means or tool to achieve a specific purpose, to neutralize the mouth, cleanse the palate, and aid in digestion, while enhancing the enjoyment and effectiveness of tastings. Currently, the product is marketed to appeal to one of the most common tastings, wine tasting; however, the product has a powerful effect with many applications.

In order to better understand the effectiveness and uniqueness that this product possesses, it is useful to understand the current conditions of the wine industry.

Currently in the United States there are wine tasting events in all major cities and towns several times a week. Wine tastings have become commonplace and a daily event for many retailers and specialty stores to draw people in and showcase their wines as well as other wares. Currently, the accompaniments for these wine tastings have been varied and inconsistent and have included such edibles as crackers, breads, cheeses, grapes and other fruits, which may have a flavor and texture that interferes with the wine experience. This inconsistency of accompaniments causes the wine taste and experience to differ with each taste and with each individual. In all cases, there is a need to correctly cleanse the palate before and during wine tasting. The palate is required to be cleansed before an official wine judgment can be established.

Accordingly, there is a need for a palate cleanser wine cookie to enhance the enjoyment and consistency of wine tastings.

### DESCRIPTION

The Palate Cleanser Wine Cookie of the present invention can provide a consistent means or tool to achieve a specific purpose. It neutralizes the mouth, cleanses the palate, and aids in digestion, while enhancing the enjoyment and effectiveness of the wine tastings.

The Palate Cleanser Wine Cookie of the present invention has a special ingredient—wine—but it is not a wine cookie. The wine in the Palate Cleanser Wine Cookie is specially blended in the ingredients, so that a product is created that has a unique consistency and texture, not a biscuit or a cracker, but a shape, a consistency and a taste that formulates it as an appealing accompaniment that cleanses the palate.

The Palate Cleanser Wine Cookie has a unique formula that causes the mouth to cleanse itself—then the product absorbs, leaving no distinctive taste, and aids in digestion.

The Palate Cleanser Wine Cookie of the present invention is unique and novel in design and size: It is indented with a “W,” is flat, round and bite-sized. These features in their entirety make it the perfect accompaniment for a one-bite tool before and between tastings of wine.

There are many items at wine tastings that are not suitable to everyone because of various food allergies, which is a widespread problem in today's society. The Palate Cleanser Wine Cookie of the present invention is specially formulated to be universally suitable for eating and appealing to all individuals. It is free of most allergens, has no cholesterol, no sodium, no dairy, no egg, and no nut products and can be made gluten-free. The Palate Cleanser Wine Cookie uses a majority of organic ingredients, is preservative- and chemical-free, while having a substantially long shelf life. This emphasizes its universal appeal to be used as a consistent, standard product and tool at wine tastings.

The Palate Cleanser Wine Cookie has been tasted and perfected by master sommeliers and wine connoisseurs as an accurate means or tool to correct and cleanse one's palate while enhancing the wine experience.

The Palate Cleanser Wine Cookie was offered as the official palate cleanser at the Grand Cm event at The Boston Wine Expo in January 2011, the world's largest wine exposition. The wine community enthusiastically received the Palate Cleanser Wine Cookie and stated it was effective.

Attendees of the International Food Wine & Travel Writers Association (IFWTWA) Conference at Sea in July 2011 received samples of The Palate Cleanser Wine Cookie, and the IFWTWA reported that “the cookies worked”.

90% of customers who tried the Palate Cleanser Wine Cookie agree or strongly agree that it effectively cleansed their palate, as reported by marketing research at Babson College, Wellesley, Mass. in June 2011.

The Palate Cleanser Wine Cookie has been tasted and offered at events to correct and cleanse the palate between entrées of food and desserts, as well as varied beverages. At events where food is paired with beers, coffee and wine, the correct change from one entrée or dessert to the next can be obtained by consuming a single Palate Cleanser Wine Cookie.

In one aspect, the present invention provides a Palate Cleanser Wine Cookie prepared from about 3½ cups of flour, about ¼-3 cups of sugar or sugar substitute, about ¼-3 cups of oil or oil substitutes, about ½-3 cups of wine or liquid substitutes, about 2 teaspoons to about 3 tablespoons of baking powder or baking soda.

In certain embodiments, the flour is selected from whole wheat, bleached or unbleached all-purpose flour, pastry flour gluten or gluten-free flour, organic flours, rice flour, and cake flour or other flour alternative substitute type flour ex. “Bisquick.”

In certain embodiments, the sugar is selected from white sugars, brown sugars, liquid sugars, fruit sugars, non-caloric sweeteners as aspartame, sucralose, acesulfame K and saccharin, fructo-oligosaccharides (FOS), tagatose, agave, “Stevia” and alternatives and substitute sugars. In certain other embodiments, substitute sugars are selected from stevia, aspartame, sucralose, neotame, acesulfame potassium, and saccharin. In yet other embodiments, substitute sugars are selected from sorbitol and xylitol.

In certain embodiments, the oil is selected from safflower, canola, vegetable, olive and oil substitutes, butter or butter substitutes.

In certain embodiments, the wine/liquid substitute is selected from alcoholic and non-alcoholic wines, red or white wines including Champagne, red or white grape juice and juice substitutions.

In another aspect, the present invention provides a method of cleansing the palate of a person for wine tastings, comprising eating at least one Palate Cleanser Wine Cookie before or between tasting different wines.

In certain embodiments, the Palate Cleanser Wine Cookie is substantially free of salt. In certain other embodiments, the Palate Cleanser Wine Cookie is substantially free of dairy product. In yet other embodiments, the Palate Cleanser Wine Cookie is substantially free of eggs. In yet other embodiments, the Palate Cleanser Wine Cookie is prepared according the recipe described herein.

In yet another aspect, the present invention provides a process of cleansing the palate of a person for wine tastings, comprising eating at least one Palate Cleanser Wine Cookie before or between tasting different wines.

In certain embodiments, the Palate Cleanser Wine Cookie is substantially free of salt. In certain other embodiments, the Palate Cleanser Wine Cookie is substantially free of dairy product. In yet other embodiments, the Palate Cleanser Wine Cookie is substantially free of eggs. In yet other embodiments, the Palate Cleanser Wine Cookie is prepared according the recipe described herein.

In a further aspect, the present invention provides a process for preparing a Palate Cleanser Wine Cookie, comprising the steps of:

(1) mixing about 3½ cups of flour, about ¼-3 cups of sugar or sugar substitute, about ¼-3 cups of oil or oil substitutes, about ½-3 cups of wine or liquid substitutes, and about 2 teaspoons to about 3 tablespoons of baking powder or baking soda in a container to provide a dough;
(2) rolling the dough;
(3) pressing the resulting dough from step 2 with a cookie cutter to provide a cut dough; and
(4) baking the cut dough from step 3 at an elevated temperature to provide a Palate Cleanser Wine Cookie.

In certain embodiments, the elevated temperature is about 350° F. to about 375° F. In certain other embodiments, the baking is conducted in an oven for about 10 to about 20 minutes.

In one aspect, the present invention provides a dough useful for preparing a palate cleanser wine cookie, comprising about 3½ cups of flour, about ¼-3 cups of sugar or sugar substitute, about ¼-3 cups of oil or oil substitutes, about ½-3 cups of wine or liquid substitutes, about 2 teaspoons to about 3 tablespoons of baking powder or baking soda.

In certain embodiments, the flour is selected from whole wheat, bleached or unbleached all-purpose flour, pastry flour gluten or gluten-free flour, organic flours, rice flour, and cake flour or other flour alternative substitute type flour ex. “Bisquick.”

In certain embodiments, the sugar is selected from white sugars, brown sugars, liquid sugars, fruit sugars, non-caloric sweeteners as aspartame, sucralose, acesulfame K and saccharin, fructo-oligosaccharides (FOS), tagatose, agave, “Stevia” and alternatives and substitute sugars.

In certain embodiments, the oil is selected from safflower, canola, vegetable, olive and oil substitutes, butter or butter substitutes. In certain other embodiments, the wine/liquid substitute is selected from alcoholic and non-alcoholic wines, red or white wines including Champagne, red or white grape juice and juice substitutions.

In a further aspect, the present invention provides a use of a palate cleanser wine cookie as described herein, as a palate cleanser for a person for wine tastings. In certain embodiments, the use is before or between tasting different wines.

In certain embodiments, the palate cleanser wine cookie is substantially free of salt. In certain other embodiments, the palate cleanser wine cookie is substantially free of dairy product. In yet other embodiments, the palate cleanser wine cookie is substantially free of eggs.

In certain embodiments, the Palate Cleanser Wine Cookie of the present invention can be prepared according to the following formula:

### TPCWC/The Palate Cleanser Wine Cookie

Note: This recipe can be increased as needed with equal equivalent measurement to all ingredients.

5 cups Flour:

Whole wheat, bleached or unbleached all-purpose flour, pastry flour gluten or gluten-free flour, organic flours, rice flour, cake flour or other flour alternative substitute type flour ex. “Bisquick”

¼-3 Cups Sugar:

White sugars, brown sugars, liquid sugars, fruit sugars, non-caloric sweeteners as aspartame, sucralose, acesulfame K and saccharin, Fructo-oligosaccharides (FOS), Tagatose, Agave, “Stevia” and alternatives and substitutes sugars

¼-3 Cups Oil

Safflower, canola, vegetable, olive and oil substitutes, butter and butter substitutes, including soy and yogurt, etc.

½-3 Cups Wine/Liquid substitutes

Alcoholic and non-alcoholic wines, red or white wines including Champagne, red or white grape juice and juice substitutions

### 2 Teaspoons-3 Tablespoons Baking Powder or Baking Soda

1. Mix liquid ingredients together

2. Add sugar

3. Add flour, sift flour with baking powder/soda

4. Blend liquid into dry ingredients

5. Roll dough

6. Press out with cookie cutter

7. Bake in oven at 350°-375° F. for 10-20 minutes

In certain other embodiments, the Palate Cleanser Wine Cookie of the present invention can be prepared according to the following organic formula:

### The Original and Authentic Wellesley Wine Tasting Cookie

### 4.5 Cups Organic Unbleached All-Purpose Flour

Brand: 365 Organic

Ingredients: wheat flour, organic malted barley Flour

¾ Cup Organic Cane Sugar

Brand: 365 Organic

Ingredients: organic cane sugar

¾ Cup Organic Canola Oil

Brand: Spectrum natural

Ingredients: 100% mechanically (expeller) pressed naturally refined organic canola oil

### 1 Cup Wine/White

Type: Chardonnay

1 tsp. Baking Powder

Brand HAIN Pure Foods, Featherweight,

*Sodium free *gluten free* aluminum-free

Ingredients: monocalcium phosphate (pure mineral), potato starch, potassium bicarbonate

1. Mix wine with sugar.

2. Add the oil

3. Using unsifted flour, sift flour with baking powder.

4. Bake in convection oven at 375° F.

1. A palate cleanser wine cookie prepared from about 3½ cups of flour, about ¼-3 cups of sugar or sugar substitute, about ¼-3 cups of oil or oil substitutes, about ½-3 cups of wine or liquid substitutes, about 2 teaspoons to about 3 tablespoons of baking powder or baking soda.

2. The palate cleanser wine cookie of claim 1, wherein said flour is selected from whole wheat, bleached or unbleached all-purpose flour, pastry flour gluten or gluten-free flour, organic flours, rice flour, and cake flour or other flour alternative substitute type flour ex. “Bisquick.”

3. The palate cleanser wine cookie of claim 1, wherein said sugar is selected from white sugars, brown sugars, liquid sugars, fruit sugars, non-caloric sweeteners as aspartame, sucralose, acesulfame K and saccharin, fructo-oligosaccharides (FOS), tagatose, agave, “Stevia” and alternatives and substitute sugars.

4. The palate cleanser wine cookie of claim 1, wherein said oil is selected from safflower, canola, vegetable, olive and oil substitutes, butter or butter substitutes.

5. The palate cleanser wine cookie of claim 1, wherein said wine/liquid substitute is selected from alcoholic and non-alcoholic wines, red or white wines including Champagne, red or white grape juice and juice substitutions.

6. A method of cleansing the palate of a person for wine tastings, comprising eating at least one palate cleanser wine cookie before or between tasting different wines.

7. The method of claim 6, wherein said palate cleanser wine cookie is substantially free of salt.

8. The method of claim 6, wherein said palate cleanser wine cookie is substantially free of dairy product.

9. The method of claim 6, wherein said palate cleanser wine cookie is substantially free of eggs.

10. The method of claim 6, wherein said palate cleanser wine cookie is prepared according to the formulation of claim 1.

11. A process of cleansing the palate of a person for wine tastings, comprising eating at least one palate cleanser wine cookie before or between tasting different wines.

12. The process of claim 11, wherein said palate cleanser wine cookie is substantially free of salt.

13. The process of claim 11, wherein said palate cleanser wine cookie is substantially free of dairy product.

14. The process of claim 11, wherein said palate cleanser wine cookie is substantially free of eggs.

15. The process of claim 11, wherein said palate cleanser wine cookie is prepared according the formulation of claim 1.

16. A process for preparing a palate cleanser wine cookie, comprising the steps of:
(1) mixing about 3½ cups of flour, about ¼-3 cups of sugar or sugar substitute, about ¼-3 cups of oil or oil substitutes, about ½-3 cups of wine or liquid substitutes, and about 2 teaspoons to about 3 tablespoons of baking powder or baking soda in a container to provide a dough;
(2) rolling the dough;
(3) pressing the resulting dough from step 2 with a cookie cutter to provide a cut dough; and
(4) baking the cut dough from step 3 at an elevated temperature to provide a palate cleanser wine cookie.

17. The process of claim 16, wherein the elevated temperature is about 350° F. to about 375° F.

18. The process of claim 16, wherein the baking is conducted in an oven for about 10 to about 20 minutes.

19. A dough useful for preparing a palate cleanser wine cookie, comprising about 3½ cups of flour, about ¼-3 cups of sugar or sugar substitute, about ¼-3 cups of oil or oil substitutes, about ½-3 cups of wine or liquid substitutes, about 2 teaspoons to about 3 tablespoons of baking powder or baking soda.

20. The dough of claim 19, wherein said flour is selected from whole wheat, bleached or unbleached all-purpose flour, pastry flour gluten or gluten-free flour, organic flours, rice flour, and cake flour or other flour alternative substitute type flour ex. “Bisquick.”

21. The dough of claim 19, wherein said sugar is selected from white sugars, brown sugars, liquid sugars, fruit sugars, non-caloric sweeteners as aspartame, sucralose, acesulfame K and saccharin, fructo-oligosaccharides (FOS), tagatose, agave, “Stevia” and alternatives and substitute sugars.

22. The dough of claim 19, wherein said oil is selected from safflower, canola, vegetable, olive and oil substitutes, butter or butter substitutes.

23. The dough of claim 19, wherein said wine/liquid substitute is selected from alcoholic and non-alcoholic wines, red or white wines including Champagne, red or white grape juice and juice substitutions.

24. Use of a palate cleanser wine cookie according to any one of claims 1-5, as a palate cleanser for a person for wine tastings.
